(19) United States
(12) Patent Application Publication
(10) Pub. No.: US 2013/0135281 A1
(43) Pub. Date: May 30, 2013

(54) LCD Device and Method of Driving the LCD Device

(71) Applicants: Hung-Lung Hou, Shenzhen (CN); Cheng-Ming He, Shenzhen (CN)

(72) Inventors: Hung-Lung Hou, Shenzhen (CN); Cheng-Ming He, Shenzhen (CN)

(73) Assignee: SHENZHEN CHINA STAR OPTOELECTRONICS TECHNOLOGY CO., LTD, Shenzhen (CN)

(21) Appl. No.: 13/380,041

(22) PCT Filed: Dec. 16, 2011
(86) PCT No.: PCT/CN11/83496

§ 371 Date: Dec. 22, 2011

(30) Foreign Application Priority Data
Nov. 25, 2011 (CN) 201110381886.5

(51) Int. Cl. G09G 3/36; G09G 5/00

(52) U.S. Cl. 345/212; 345/87

(57) ABSTRACT

The present invention provides a liquid crystal display (LCD) device and a driving method thereof capable of providing an enabling signal to the pixel unit which displaying different grayscales in the current frame signal and the previous frame signal via a plurality of secondary signal lines after determining the current frame signal is not identical with the previous frame signal. And the pixel unit conducts the data voltage outputted from the data line to the liquid crystal capacitor to adjust alignment of liquid crystal molecules in case of the first transistor receiving the scan signal pulse outputted from the corresponding scan line and the second transistor receiving the enabling signal outputted from the secondary signal lines. In this way, power consumption of the LCD device is reduced.

### BACKGROUND OF THE INVENTION

1. Field of the Invention

The present invention relates to a liquid crystal display (LCD) device and a driving method thereof, and more particularly, to an LCD device and a method of driving the LCD device, thereby reducing power consumption.

2. Description of the Prior Art

Owing to their low-profile, thin, and lightweight features, LCD devices have replaced cathode ray tubes (CRTs) in many applications and becomes the mainstream display devices in recent years. LCD panels are widely used in electronic devices such as mobile phones, personal digital assistants (PDAs), digital cameras, computer screens, notebook screens, etc.

A conventional LCD panel comprises a plurality of pixel units. Each of the plurality of pixel units is sub-divided into three pixel units colored red, green, and blue (RGB). A data driving module outputs a scan signal through a scan line to activate the thin-film transistor (TFT) on each pixel unit in each row to be turned on in order. Meanwhile, a data driving module outputs a corresponding data signal to the TFT through a data line. The data signal passes through the TFT and is transmitted to a liquid crystal capacitor so that each of the liquid crystal capacitors us charged to its required voltage to display different grayscales. The scan driving module outputs the scan signal row by row to turn on the TFT on the pixel in each row. Then, the data driving module charges/discharges the pixel electrode in each row. Depending upon this sequence, an image will be completely shown on the LCD panel.

Traditionally, LCD devices are operated under a frame rate of 60 Hertz (Hz). For the purpose of displaying better dynamic images, LCD devices have been developed to be operated under a frame rate of 120 Hz and 240 Hz. The LCD devices operated under a frame rate of 120 Hz or 240 Hz have better display performance than those operated under a frame rate of 60 Hz do. Compared with the LCD device operated under a low frame rate, the LCD device operated under a high frame rate can show more images during a fixed period of time, making dynamic images smoother. In other words, a high frame rate can enhance the quality of dynamic images.

However, power consumption of the LCD device is proportion to a frame rate and whole capacitance of all liquid crystal capacitors. In other words, the greater frame rate or the whole capacitance is, the more power consumption of an LCD device is.

Furthermore, some neighboring frames are unchanged actually when the LCD device operated under a higher frame rate (e.g., 120 Hz and 240 Hz) displays static images for a while. Although the neighboring frames do not change, liquid crystal capacitors is still to be charged by a stable bias current, thereby increasing power consumption of the entire LCD device. Therefore, it is an object to reduce power consumption of LCD devices more effectively.

### SUMMARY OF THE INVENTION

Accordingly, an object of the present invention is to provide an LCD device and a driving method capable of conducting a pixel unit which displays different grayscales based on a current frame signal and a previous frame signal to reduce power consumption of LCD devices after determining that the current frame signal is not identical with the previous frame signal.

According to the present invention, a liquid crystal display (LCD) device comprising a plurality of pixel units, a processing unit, a scan driving module, a data driving module, a plurality of scan lines and a plurality of data lines, the scan driving module electrically connected to the plurality of scan lines and used for generating scan signal pulses, the data driving module electrically connected to the plurality of data lines for generating data voltages, the processing unit for generating a plurality of frame signals, each frame signal comprises a plurality of video signals, and the plurality of pixel units correspond to the plurality of frame signals one by one. The LCD device further comprises: a plurality of secondary signal lines electrically connected to the plurality of pixel units; a determining unit electrically connected to the plurality of secondary signal lines, for providing an enabling signal to the pixel units via the plurality of secondary signal line electrically connected to the pixel units when determining a current frame signal is not identical with a previous frame signal. Each pixel comprises a first transistor electrically connected to a scan line and a data line correspondingly and used for conducting the data voltages transmitted from the corresponding data line when receiving a scan signal pulse transmitted from the corresponding scan line; a second transistor electrically connected to a corresponding secondary signal line and the first transistor and used for conducting the data voltages transmitted from the first transistor when receiving the enabling signal transmitted from the corresponding secondary signal line; and a liquid crystal capacitor comprising a plurality of liquid crystal molecules, electrically connected to the second transistor and used for adjusting alignment of the plurality of liquid crystal molecules based on the data voltages.

In one aspect of the present invention, the LCD device further comprises a buffer electrically connected to the processing unit and for storing the plurality of frame signals of frames.

In another aspect of the present invention, the buffer is a first in first out buffer.

In yet another aspect of the present invention, a gate, a source and a drain of the first transistor are electrically connected to the corresponding scan line, the corresponding data line and a source of the second transistor, a gate and a drain of the second transistor are electrically connected to the corresponding secondary signal line and the liquid crystal capacitor.

In still another aspect of the present invention, the second transistor is turned off when not receiving the enabling signal transmitted from the corresponding secondary signal line.

According to the present invention, a method of driving a liquid crystal display (LCD) device. The LCD device comprises a processing unit, a plurality of pixel units, a scan driving module, a data driving module, a plurality of scan lines a plurality of data lines, and a plurality of secondary lines. Each frame signal is a combination of a plurality of video signals, and the plurality of pixel units corresponding to the plurality of frame signals one by one. Each pixel comprises a first transistor electrically connected to a scan line and a data line correspondingly, a second transistor electrically connected to a corresponding secondary signal line and the first transistor, and a liquid crystal capacitor comprising a plurality of liquid crystal molecules, electrically connected to the second transistor. The method comprises: providing an enabling signal to the pixel units via the plurality of secondary signal line electrically connected to the pixel units when determining a current frame signal is not identical with a previous frame signal; and conducting the data voltage from the data line to the liquid crystal capacitor to adjust an alignment of the plurality of liquid crystal molecules, when the first transistor receives a scan signal pulse from the scan line and the second transistor receives the enabling signal from the secondary line.

In one aspect of the present invention, the LCD device further comprises a buffer electrically connected to the processing unit and for storing the plurality of frame signals of frames.

In another aspect of the present invention, the buffer is a first in first out buffer.

In yet another aspect of the present invention, a gate, a source and a drain of the first transistor are electrically connected to the corresponding scan line, the corresponding data line and a source of the second transistor, a gate and a drain of the second transistor are electrically connected to the corresponding secondary signal line and the liquid crystal capacitor.

In still another aspect of the present invention, the method further comprises a step of turning off the second transistor when not receiving the enabling signal transmitted from the corresponding secondary signal line.

In contrast to prior art, the present invention provides an LCD device and a driving method capable of providing an enabling signal to the pixel unit which displaying different grayscales in the current frame and in the previous frame via a plurality of secondary signal lines after determining the current frame signal is not identical with the previous frame signal. And the pixel unit conducts the data voltage outputted from the data line to the liquid crystal capacitor to adjust alignment of the liquid crystal molecules in case of the first transistor receiving the scan signal pulse outputted from the corresponding scan line and the second transistor receiving the enabling signal outputted from the secondary signal lines. In this way, power consumption of the LCD device is reduced accordingly.

These and other features, aspects and advantages of the present disclosure will become understood with reference to the following description, appended claims and accompanying figures.

### BRIEF DESCRIPTION OF THE DRAWINGS

FIG. 1 shows a block diagram of a liquid crystal display (LCD) device according to a preferred embodiment of the present invention.

FIG. 2 is a top view of the pixel units in FIG. 1.

FIG. 3 is an equivalent circuit diagram of the pixel units in FIG. 1.

FIG. 4 illustrates an example of the different frame signal of a current frame and a previous frame.

FIG. 5 is a timing diagram of a scan signal pulse and an enabling signal provided by the scan lines and the secondary signal lines in FIG. 2.

FIG. 6 is a flowchart of a method for driving the LCD device according to the preferred embodiment of the present invention.

### DETAILED DESCRIPTION OF THE PREFERRED EMBODIMENTS

Certain terms are used throughout the description and following claims to refer to particular components. As one skilled in the art will appreciate, electronic equipment manufacturers may refer to a component by different names. This documents does not intend to distinguish between components that differ in name but not function. In the following description and in the claims, the terms “include” and “comprise” are used in an open-ended fashion, and thus should be interpreted to mean “include, but not limited to . . . ” Also, the term “electrically connect” is intended to mean either an indirect or direct electrical connection. Accordingly, if one device is coupled to another device, that connection may be through a direct electrical connection, or through an indirect electrical connection via other devices and connections.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

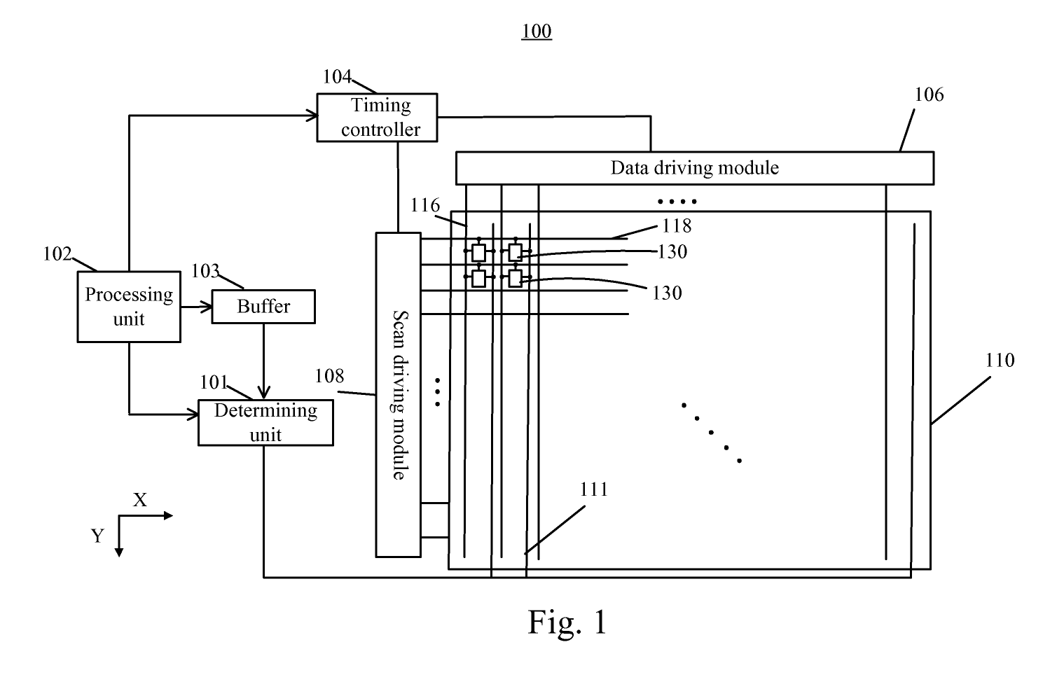

Refer to FIG. 1. FIG. 1 shows a block diagram of a liquid crystal display (LCD) device 100 according to a preferred embodiment of the present invention. The LCD device 100 comprises a determining unit 101, a processing unit 102, a buffer 103, a timing controller 104, a data driving module 106, a scan driving module 108 and an LCD panel 110. The LCD panel 110 comprises a plurality of pixel units 130, a plurality of scan lines 118 along with a first direction X, a plurality of data lines 116 along with a second direction Y and a plurality of secondary signal lines 111. The first direction X is perpendicular to the second direction Y. A plurality of secondary signal lines 111 in the embodiment are along with the second direction Y as well. But, a plurality of secondary signal lines 111 extended along with the first direction X is also allowed.

The processing unit 102 may be a central processing unit of a personal computer or of a notebook computer, and is used for simultaneously outputting multiple frames to the determining unit 101, the timing controller 104 and the buffer 103. A frame signal indicates a combination of multiple video signals applied on all pixel units 130 (e.g. 1024×768×3 pixel units) in a period of a frame display. Take the LCD device 100 having a resolution 1024×768 and operated under a frame rate of 60 Hz for example, a frame signal indicates a combination of multiple video signals of applied on 1024×768×3 pixel units 130 in 1/60 second.

The buffer 103 is a first in first out buffer for temporarily storing at least two frames, which are a current frame signal and a previous frame signal. The buffer 103 removes the earliest-stored frame signal before storing another frame signal when the buffer is full. The timing controller 104 is used for generating frequency pulse signals to the scan driving module 108 and for transforming the received frame signals into data signals. The scan driving module 108 is used for outputting scan signals based on the frequency pulse signals. The data driving module 106 is used for transforming the data signals into grayscale voltage at different voltage levels. The data driving module 106 and the scan driving module 108 may be disposed on a flexible circuit board (not shown) by using a chip on film (COF) technology or on a glass substrate (not shown) by using a chip of glass (COG). After the frequency pulse signal generated by the timing controller 104 is transmitted to the scan driving module 108, the scan driving module 108 generates a plurality of scan signals to the LCD panel 110 sequentially, so that transistors (not shown) of the plurality of pixel units 130 in every row on the LCD panel 110 can be turned on sequentially. While the transistors of the pixel units 130 in a row are turned on, the data driving module 106 outputs the grayscale voltages to the pixel units 130 so that liquid crystal capacitors (not shown) of the pixel units 130 in the same row can be charged to the voltage level of the grayscale voltages for displaying different grayscales.

The determining unit 101 is electrically connected to the plurality of secondary signals 111 and used for determining that if a current frame signal is identical with a previous frame signal. The determining unit 101 transmits an enabling signal to the plurality of pixel units 130 which displaying different grayscales based on the current frame signal and the previous frame signal via the plurality of secondary signal lines 111 after determining the current frame signal is not identical with the previous frame signal.

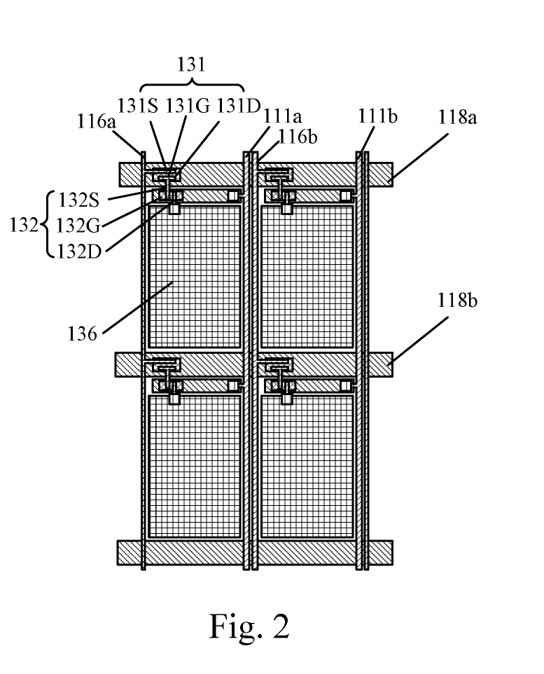

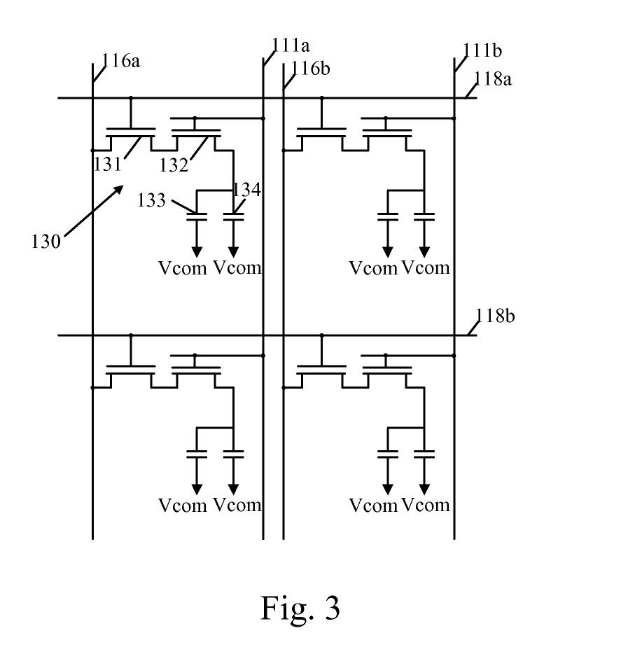

Refer to FIG. 2 and FIG. 3. FIG. 2 is a top view of the pixel units 130 in FIG. 1. FIG. 3 is an equivalent circuit diagram of the pixel units 130 in FIG. 1. Each pixel unit 130 comprises a first transistor 131, a second transistor 132, a liquid crystal capacitor 133 and a storage capacitor 134. A gate 131G, a source 132S and a drain 132D of the first transistor 131 are electrically connected to the scan line 131, the data line 116 and the drain 132S of the second transistor 132, respectively. A gate 132G and a drain 132D of the second transistor 132 are electrically connected to the secondary signal line 111 and the liquid capacitor 133, respectively. Take the plurality of pixel units 130 electrically connected to the scan line 118a, the data line 116a and the secondary line 111a for instance, the first transistor 131 conducts a data voltage outputted from the data line 116a while receiving a scan signal pulse from the scan line 118a. The second transistor 132 conducts a data voltage outputted from the first transistor 131 while receiving an enabling signal from the secondary signal line 111a. The liquid crystal capacitor 133 formed by a pixel electrode 136 and a common electrode (not shown) adjusts the alignment of the plurality of liquid crystal molecules between the pixel electrode 136 and the common electrode based on a voltage difference between the data voltage and a common voltage Vcom supplied by the common electrode. The storage capacitor 134 is used for preserving the data voltage until receiving the next scan signal pulse.

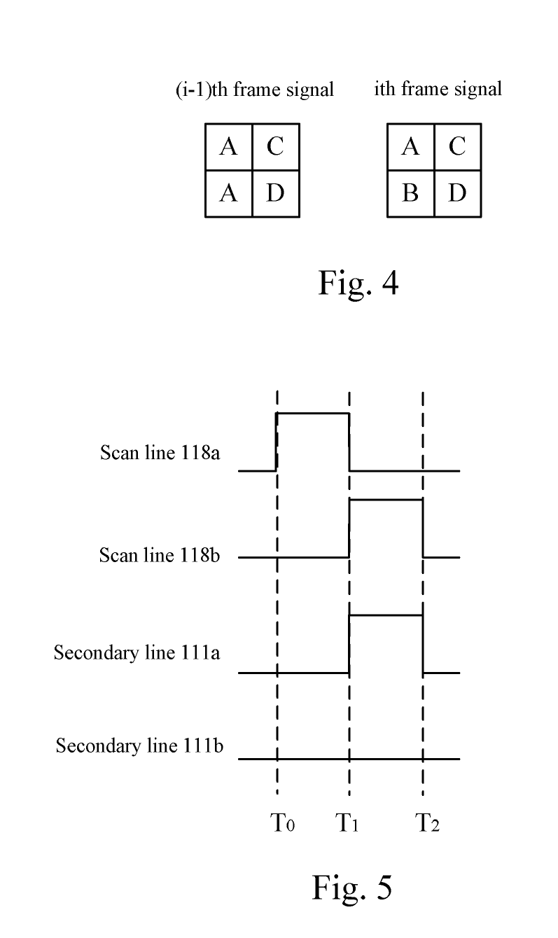

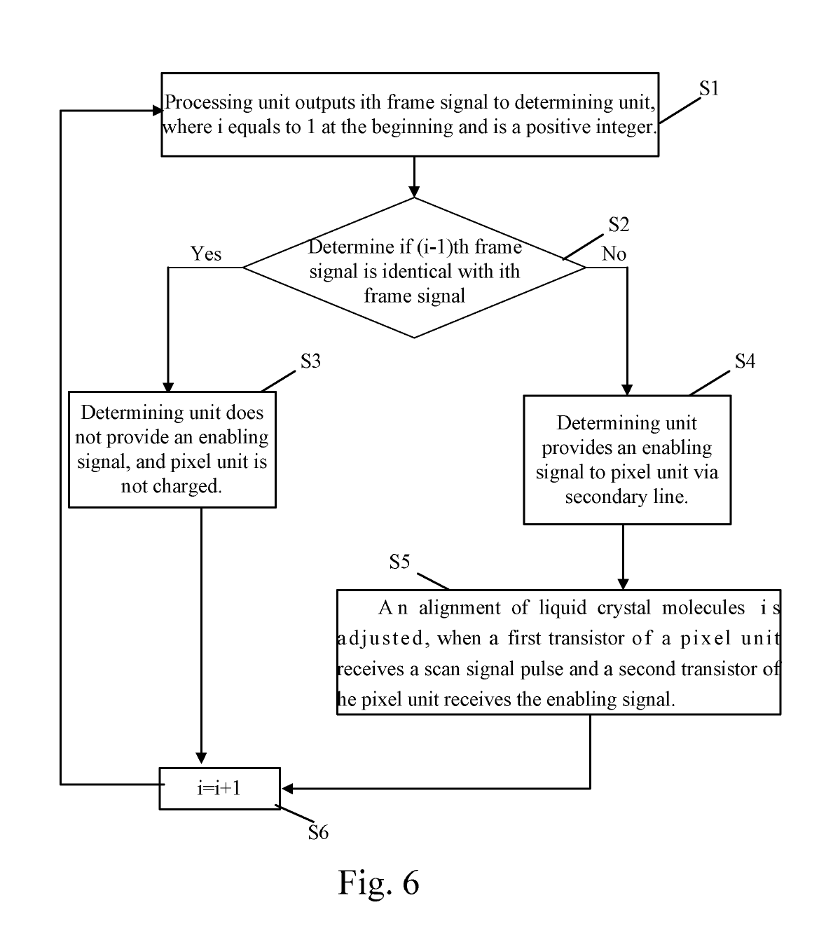

Refer to FIG. 3, FIG. 4, FIG. 5 and FIG. 6. FIG. 4 illustrates an example of the different frame signal of a current frame and a previous frame. FIG. 5 is a timing diagram of a scan signal pulse and an enabling signal provided by the scan lines and the secondary signal lines in FIG. 2. FIG. 6 is a flowchart of a method for driving the LCD device according to the preferred embodiment of the present invention. For simplicity, the four blocks in FIG. 4 denote the video signals relating to the (i−1)th and ith frame signals applied on the four pixel units 130 in FIG. 2. The processing unit 102 is capable of simultaneously outputting the ith frame signal to the buffer 103, the determining unit 101 and the timing controller 104, where i equals to 1 at the beginning and is a positive integer (step S1). After receiving the ith frame signal, the timing controller 104 transmits a frequency pulse signal to the scan driving module 108. Next, the timing controller 104 transforms the ith frame signal into a plurality of data signals and outputs the plurality of data signals to the data driving module 106. The scan driving module 108 generates a plurality of scan signal pulse to the LCD panel 110 sequentially based on the frequency pulse signal, so that thin-film transistors (TFTs) of the plurality of pixel units 130 in every row on the LCD panel 110 can be turned on sequentially. While the TFTs of the plurality of pixel units 130 in a row are turned on, the data driving module 106 outputs a plurality of data voltages based on the plurality of data signals.

The determining unit 101 determines if the (i−1)th frame signal (stored in the buffer 103) is identical with the ith frame signal (step S2) and stores the ith frame signal into the buffer 103 when receiving the ith frame signal.

Take FIG. 4 as instance. The video signals of the (i−1)th frame signal applied on the left-upper and right-upper pixel units 130 are identical with those of the ith frame signal, so that the determining unit 101 does not provide an enabling signal (step S3). Therefore, in the period of T₀-T₁, the scan line 118a transmits the plurality of scan signal pulses to turn on the first transistor 131 of the left-upper and right-upper pixel units 130, but the second transistor 132 is turned off on account of no enabling signals transmitted by the secondary signal line 111a and 111b. Consequently, the liquid crystal capacitor 133 is not able to be charged by receiving data voltages because of turn-off of the second transistor 132, even if the data line 116a and 116b still transmit data voltages through the data driving module 106. The liquid crystal capacitor 133, however, maintains the display of previous frame according to the charge stored by the storage capacitor 134.

Because the video signal of the (i−1)th frame signal applied on a left-lower pixel unit 130 is not identical with that of the ith frame signal, the determining unit 101 provides an enabling signal to the pixel units 130 via the secondary signal line 111a (step S4). Therefore, in the period of time T₁-T₂, the scan line 118a transmits the scan signal pulse to turn on the first transistor 131 of the left-lower pixel units 130 , and the second transistor 132 is also turned on because of enabling signals transmitted by the secondary signal line 111a. In hence, the liquid crystal capacitor 133 is charged by the data voltages from the data line 116a, so that alignment of the liquid crystal molecules is adjusted based on the data voltages (step S5).

After the step S4 and S5 are finished, go on to processing a frame signal of next frame (step S6).

Only four pixel units 130 are used in the embodiment to demonstrate the operation principle of the present invention. Most of the liquid crystal capacitor 133 of the pixel units 130, but a few, are not to be recharged because of the turn-off of the second transistor 132 when the ith frame signal is almost identical with the (i−1)th frame. Therefore, the LCD device 100 and the driving method are capable of reducing power consumption.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A liquid crystal display (LCD) device comprising a plurality of pixel units, a processing unit, a scan driving module, a data driving module, a plurality of scan lines and a plurality of data lines, the scan driving module electrically connected to the plurality of scan lines and used for generating scan signal pulses, the data driving module electrically connected to the plurality of data lines for generating data voltages, the processing unit for generating a plurality of frame signals, each frame signal comprises a plurality of video signals, and the plurality of pixel units correspond to the plurality of frame signals one by one, characterized in that, the LCD device further comprises:
a plurality of secondary signal lines electrically connected to the plurality of pixel units;
a determining unit electrically connected to the plurality of secondary signal lines, for providing an enabling signal to the pixel units via the plurality of secondary signal line electrically connected to the pixel units when determining a current frame signal is not identical with a previous frame signal; and
each pixel comprising:
a first transistor electrically connected to a scan line and a data line correspondingly and used for conducting the data voltages transmitted from the corresponding data line when receiving a scan signal pulse transmitted from the corresponding scan line;
a second transistor electrically connected to a corresponding secondary signal line and the first transistor and used for conducting the data voltages transmitted from the first transistor when receiving the enabling signal transmitted from the corresponding secondary signal line; and
a liquid crystal capacitor comprising a plurality of liquid crystal molecules, electrically connected to the second transistor and used for adjusting alignment of the plurality of liquid crystal molecules based on the data voltages.

2. The LCD device of claim 1, characterized in that: The LCD device further comprises a buffer electrically connected to the processing unit and for storing the plurality of frame signals of frames.

3. The LCD device of claim 2, characterized in that: the buffer is a first in first out buffer.

4. The LCD device of claim 1, characterized in that: a gate, a source and a drain of the first transistor are electrically connected to the corresponding scan line, the corresponding data line and a source of the second transistor, a gate and a drain of the second transistor are electrically connected to the corresponding secondary signal line and the liquid crystal capacitor.

5. The LCD device of claim 1, characterized in that: the second transistor is turned off when not receiving the enabling signal transmitted from the corresponding secondary signal line.

6. A method of driving a liquid crystal display (LCD) device comprising a processing unit, a plurality of pixel units, a scan driving module, a data driving module, a plurality of scan lines a plurality of data lines, and a plurality of secondary lines, each frame signal being a combination of a plurality of video signals, and the plurality of pixel units corresponding to the plurality of frame signals one by one, characterized in that, each pixel comprising:
a first transistor electrically connected to a scan line and a data line correspondingly;
a second transistor electrically connected to a corresponding secondary signal line and the first transistor; and
a liquid crystal capacitor comprising a plurality of liquid crystal molecules, electrically connected to the second transistor; the method comprising:
providing an enabling signal to the pixel units via the plurality of secondary signal line electrically connected to the pixel units when determining a current frame signal is not identical with a previous frame signal; and
conducting the data voltage from the data line to the liquid crystal capacitor to adjust an alignment of the plurality of liquid crystal molecules, when the first transistor receives a scan signal pulse from the scan line and the second transistor receives the enabling signal from the secondary line.

7. The method of driving the LCD device of claim 6, characterized in that: The LCD device further comprises a buffer electrically connected to the processing unit and for storing the plurality of frame signals of frames.

8. The method of driving the LCD device of claim 7, characterized in that: the buffer is a first in first out buffer.

9. The method of driving the LCD device of claim 6, characterized in that: a gate, a source and a drain of the first transistor are electrically connected to the corresponding scan line, the corresponding data line and a source of the second transistor, a gate and a drain of the second transistor are electrically connected to the corresponding secondary signal line and the liquid crystal capacitor.

10. The method of driving the LCD device of claim 6, characterized in that: the method further comprises a step of turning off the second transistor when not receiving the enabling signal transmitted from the corresponding secondary signal line.
